(19) United States
(12) Patent Application Publication
(10) Pub. No.: US 2005/0122486 A1
(43) Pub. Date: Jun. 9, 2005

(54) Projection device

(76) Inventor: Arne Trollsch, Grossschwabhausen (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/954,762

(22) Filed: Sep. 30, 2004

(30) Foreign Application Priority Data
Sep. 30, 2003 (DE) 103 45 433.0

(51) Int. Cl. G03B 21/26

(52) U.S. Cl. 353/94

(57) ABSTRACT

A projector for multicolor images includes light sources, which emit light of different wavelengths. The projector uses additive mixing of colors of the light from said three light sources and the maximum luminous flux at the white point is limited by the maximum luminous flux of the first light source. the projector make a white balance adjustment by adjusting the intensity and/or on-state times of the light sources.

### BACKGROUND OF THE INVENTION

The invention relates to a projection device comprising first, second and third light sources, which emit light of different wavelengths, wherein, by additive mixing of colors of the light from said three light sources, the maximum luminous flux at the white point is limited by the maximum luminous flux of the first light source, a color unit coupling the light from the light sources into an illumination channel, a light modulator device, which immediately follows the illumination channel and modulates the light from the light sources, and projection optics projecting the modulated light onto a projection surface.

In order to achieve a maximum luminous flux of the projected light, the light modulator device, in many cases, comprises three light modulators, which are associated with the three light sources, so that one partial color image each of the image to be projected can be generated with each light modulator. However, this is connected with a considerable optical complexity, which makes the projection device heavy and expensive.

In view thereof, it is an object of the invention to improve the above-mentioned projection device such that a maximum luminous flux of the projected image is achieved with reduced complexity.

### SUMMARY OF THE INVENTION

According to the invention, this is achieved by a projection device of the aforementioned type in that the light modulator device comprises a first and a second light modulator (in particular only the first and second light modulator) as well as a color-splitting unit, arranged preceding the light modulators, on which light from the illumination channel impinges and which directs the light from the first light source onto the first light modulator and the light from the second and third light sources onto the second light modulator, in that a color combining unit, which directs the modulated light coming from the light modulators to the projection optics, is provided as well as a control unit, which causes the second light modulator to be illuminated with the light from the second and third light sources sequentially in time and which effects a white balance adjustment via the intensity and/or on-state times of the light sources.

In this connection, the projection device according to the invention makes use of the fact that in light emitting diode light sources, in particular, the actually achievable luminous flux differs considerably from the luminous flux required in order to effect a white balance adjustment. Thus, for example, a light emitting diode which emits blue light (wavelength 455 nm) with a luminous flux of 5.0 lm (lm=lumen), a light emitting diode which emits green light (wavelength 530 nm) with a luminous flux of 25 lm, and a light emitting diode which emits red light (wavelength 627 nm) with a luminous flux of 44 lm are available. However, the luminous flux required for a white balance adjustment at a color temperature of 6,500 K is only 2.5 lm, 25 lm and 9.8 lm, respectively, for the colors blue, green and red (in relation to the color green). Due to the marked excess of the available blue and red luminous fluxes, it is therefore sufficient if the second light modulator is illuminated sequentially in time with the blue light (50% of the time) and the red light (22% of the time) and is not illuminated at all 28% of the time, if the first light modulator is constantly illuminated with the green light. In this case, there results a luminous flux of 37.3 lm (2.5 lm+25 lm+9.8 lm). This luminous flux is of the same magnitude as that of a projection device that would comprise three light modulators that each respectively have the colors red, green and blue impinging on them, because the limiting luminous flux is that of the green light emitting diode. Thus, even in a projection device comprising three light modulators, a maximum luminous flux of only 37.3 lm can be achieved for a white balance adjustment at a color temperature of 6,500 K with the above-described light emitting diodes. Thus, in the presently described example, the projection device according to the invention even achieves the same efficiency as a projection device comprising three light modulators and, in comparison therewith, is optically much less complex.

The control device preferably controls the application of the light from the light sources to the light modulators such that, at a given color temperature, a luminous flux limited by the luminous flux of the first light source is achieved at the white point. This allows optimal use of the light sources as described in the above numerical example.

The use of light emitting diode light sources is also advantageous insofar as the otherwise common reflectors in white-light sources and the required color splittings can be avoided. Further, the light emitting diodes have an extremely long life. Finally, in the projection device according to the invention, the light emitting diodes are also preferably switched on only when their light is needed. This further increases the life of the light emitting diodes and reduces the heat developed by them.

In particular, the light modulators in the projection device according to the invention may be provided as reflective light modulators and the color-splitting unit as well as the color-combining unit may be the same unit. This, in turn, increases the compactness of the projection device.

In a preferred embodiment of the projection device according to the invention, the color unit couples light into the illumination channel, independently of the polarization of the light from the light sources, and a first polarization unit, which imposes a different polarization condition on the light from the first light source than that of the light from the second and third light sources, is arranged in the illumination channel. In this case, the color-splitting unit effects color splitting as a function of the polarization condition of the light. This allows an excellent splitting to be achieved of the light from the first light source, on the one hand, and of the light from the second and third light sources, on the other hand. This is particularly advantageous, if polarization-sensitive light modulators are used as the light modulators. In this case, a suitable polarization condition is immediately imposed on the light by means of the first polarization unit.

Further, in the projection device according to the invention, the color unit may be polarization-sensitive, and the light from the first light source of the color unit may be supplied with a different polarization condition than the light from the second and third light sources, wherein the color-splitting unit effects color splitting as a function of the polarization condition of the light. This procedure is particularly preferred, if the light sources emit already polarized light. If the light sources do not emit polarized light, an excellent polarization can be effected in this embodiment, because polarization of the light is effected before superposition in the illumination channel.

Further, in the projection device according to the invention, a second polarization unit, which imparts the same polarization condition to the modulated red, green and blue light, may be arranged between the color-combining unit and the projection optics. If the second polarization unit additionally comprises a polarizer which only allows light of said polarization condition to pass, a marked improvement in contrast will be achieved in the projected image.

A particularly preferred embodiment of the projection device according to the invention consists in that a first lens array is provided between at least one of the light sources and the color unit, and focussing optics having positive refractive power are arranged between the color unit and the light modulator, wherein the first lens array and the focussing optics form a honeycombed condensing system or a honeycombed condensor system, respectively. Using such a honeycombed condensing system, an excellently homogeneous illumination of the light modulators can be achieved. At the same time, the projection device is extremely compact, because the required color unit is arranged within the honeycombed condensing system, so that the required space is minimized.

In particular, the honeycombed condensing system is provided such that the optical distance from the focussing optics to the first lens array, on the one hand, and to the light modulators, on the other hand, respectively corresponds to the focal length of the focussing optics. This allows optimal illumination to be achieved with minimal dimensions. In this case, the honeycombed condensing system corresponds to a system having a telecentric beam path on the image-side and etendue conservation.

A further embodiment of the projection device according to the invention consists in that the honeycombed condenser system comprises, between each first lens array and each corresponding light source, a second lens array, with the focal points of the lenses of the second lens array preferably being located in the plane of the first lens array. The use of two lens arrays arranged following each other makes it particularly easy to adjust the homogenization to a determined aspect ratio of the surface to be illuminated in the light modulators, in particular if said surface is rectangular. Thus, for example, use can be made of two cylinder lens arrays which are rotated 90° relative to each other, so that the desired rectangular aspect ratio is easily adjustable. This is also particularly advantageous insofar as cylinder lens arrays are easy to manufacture.

The two lens arrays arranged following each other may be provided as tandem lens arrays, wherein the lens arrays are arranged on the front and rear surfaces of a substrate. Thus, a very compact optical element is provided allowing the entire illumination device to have a compact design. The two lens arrays are preferably equal in design and adjusted relative to each other.

Instead of two cylinder lens arrays, use may also be made of one single lens array, wherein the lenses are arranged in lines and columns, thus reducing the number of the array. Such lens array may be provided such that it has the same optical effect as two cylinder lens arrays arranged following each other, which are preferably rotated 90° relative to each other, and it may, of course, be further embodied as a tandem lens array, too.

It is further possible to provide an additional tandem lens array between the tandem lens array and the respective light source. In this case, both tandem lens arrays may be provided as tandem cylinder lens arrays which are rotated relative to each other. Different lens parameters of the cylinder lens arrays of the two tandem cylinder arrays enable an optimal adjustment to the surface to be illuminated (in particular, if said surface is rectangular).

Further, the focussing optics may comprise or consist of a lens provided as a Fresnel lens. This has the advantage that the space between the focussing lens and the color unit, on the one hand, and the light modulators, on the other hand, increases without having to increase the dimensions of the projection device as a whole.

It is particularly preferred in the projection device according to the invention to provide the focussing optics as an aspheric lens. Thus, the required imaging properties can be realized by means of just one single lens.

In a further preferred embodiment of the projection device according to the invention, the color unit comprises first and second combining units, with the first combining unit directing the light from the second and third light sources into a partial beam path extending from the first combining unit to the second combining unit, in which one of the first microlens arrays is arranged as common microlens array for the second and third light sources. The second combining unit directs the light from the partial beam path and the light from the first light source into the illumination channel. On the whole, this makes the projection device very compact, because only one lens array needs to be provided for two light sources. It also reduces the number of optical elements, so that the projection device can be manufactured at reduced cost and has less weight.

The second combining unit and/or the first combining unit can be realized as a wire grid polarizer, a polarizing beam splitter or by means of glass plates having a dichroic coating.

### BRIEF DESCRIPTION OF THE DRAWINGS

The invention will be explained in more detail below, by way of example, with reference to the Figures, wherein:

FIG. 1 shows a first embodiment of the projection device according to the invention;

FIG. 2 shows a schematic representation explaining the optical principle of the honeycombed condensing system employed in FIG. 1;

FIG. 3 shows a second embodiment of the projection device according to the invention, and

FIG. 4 shows a third embodiment of the projection device according to the invention.

### DETAILED DESCRIPTION OF THE INVENTION

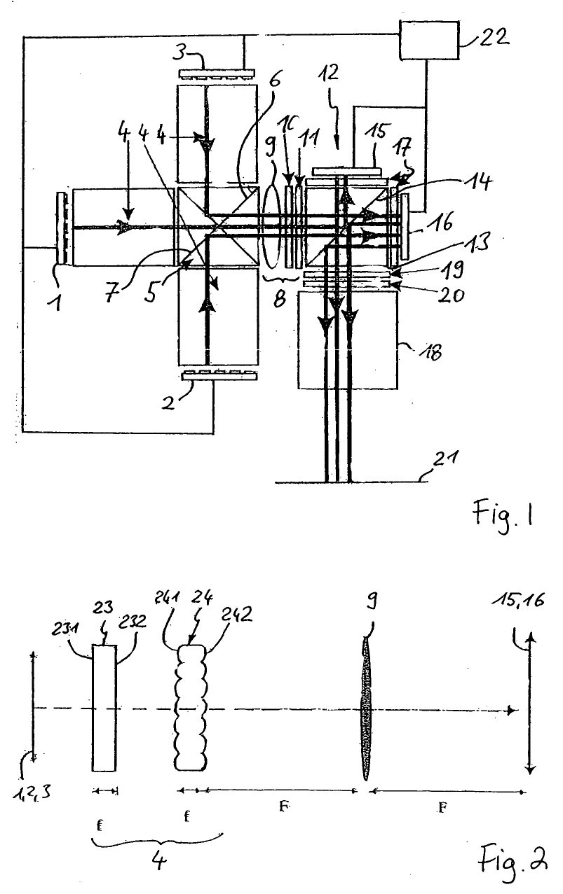

In the embodiment shown in FIG. 1, the projection device comprises first, second and third light emitting diode light sources 1, 2, 3, which emit green, blue and red light. Following each of the light sources 1 to 3, there are provided lens arrays 4, which are shown only schematically in FIG. 1, directing the light from the light sources 1 to 3 onto three sides of a color unit 5 provided as a color cube. The color cube 5 comprises two intersecting color-splitting layers 6 and 7, which enclose an angle of 90° together and which are respectively tilted 45° relative to the direction of light propagation of the light from the light sources 1 to 3.

The color unit 5 directs the light from the light sources 1 to 3 into an illumination channel 8, in which there are arranged, in this sequence as seen in the direction of light propagation, a focussing lens 9 having positive refractive power, a polarizer 10 for linearly polarizing the light passing through it, as well as a wavelength-selective retarder 11.

Following the illumination channel 8, there is arranged a light modulator device 12, which comprises a polarizing beam splitter 13 having a splitting surface 14 which is tilted 45° to the direction of light propagation, as well as two reflective and polarization-sensitive light modulators 15 and 16. Further, λ/4 retarders 17 can also be provided between the light modulators 15, 16 and the polarizing beam splitter, respectively.

The light from the light sources 1 to 3, which passes through the illumination channel 7, is linearly polarized by means of the polarizer 10 such that the light is p-polarized with respect to the splitting surface 14 of the polarizing beam splitter 13. The subsequently arranged retarder 11 is adapted to rotate the polarization direction only of the green light around 90° so that this light is now s-polarized with respect to the splitting surface 14. In the polarizing beam splitter 13, the s-polarized light (i.e. the green light) is then reflected upwardly (as seen in FIG. 1) by the splitting layer 14, and the p-polarized light (i.e. the red and blue light) is transmitted.

In the embodiment without the λ/4 retarder 17, the polarization condition of the light impinging on pixels to be darkened is not changed, whereas the polarization condition of the light impinging on pixels to be brightened is rotated around 90°. Thus, the light of the pixels to be darkened (with respect to the green light) is reflected back into the illumination channel 8 again by the splitting layer 14 and is transmitted, with respect to the red and blue light, through the splitting layer 14 and thus enters the illumination channel 8. The green light, whose polarization direction has been rotated around 90°, passes through the splitting layer 14 in a downward direction (as seen in FIG. 1), and the red and blue light, whose polarization has also been rotated around 90°, is reflected by the splitting layer 14 and, thus, also passes down and impinges on projection optics 18. As shown in FIG. 1, there may also be provided, between the projection optics 18 and the polarizing beam splitter 13, a wavelength-selective retarder 19, which only rotates the polarization direction of the green light around 90°, so that the green, blue and red light have the same polarization, and a polarizer 20, which ensures that only light having the predetermined polarization condition passes to the projection optics. The retarder 19 and the polarizer 20 serve to improve contrast.

The light is then projected onto a projection surface 21 by means of the projection optics 18.

Further, a control unit 22 is also provided, which controls the light modulators 15 and 16 as well as the light sources 1-3 on the basis of given image data.

The light sources 1-3 used here have a luminous flux of 25 lm (green light emitting diodes), 5.0 lm (blue light emitting diodes) and 44 lm (red light emitting diodes). However, for a luminous flux of 25 lm for the green light emitting diodes, a white balance adjustment at a color temperature of 6,500 K requires a luminous flux of only 2.5 lm for the blue light emitting diodes and of only 9.8 lm for the red light emitting diodes. Therefore, the light emitting diodes of the light sources 1-3 are controlled by means of the control unit 22 such that the green light emitting diodes are permanently switched on, so that the first light modulator 15 also permanently has green light impinging on it. However, in relation to a given time unit, the blue light emitting diodes (second light source) are switched on only 50% of said time unit. The red light sources of the third light source are switched on 22% of said time unit, so that the second light modulator 16 has red light and blue light impinging thereon sequentially in time and is not illuminated at all 28% of said time unit. Thus, a green partial color image is permanently generated and red and blue partial images are temporarily generated by means of the light modulators 15 and 16, which are superimposed by means of the polarizing beam splitter 13 and projected onto the projection surface 21 by means of the projection optics 18. Thus, in the described projection device, the light sources 1-3 can be optimally utilized to achieve an excellent color display.

The optional λ/4 retarders 17 serve to improve contrast. In addition, said λ/4 retarders 17 are arranged such that the fast axis of the retarder is located parallel (or perpendicular) to the input polarization. Thus, the rotation, which is caused by the splitting layer and depends on the angle of incidence, which varies due to the divergence of the light beams, of the polarization direction of the incident light is compensated for. This is often also referred to as compensation of geometric effects on the splitting layer.

FIG. 2 is a schematic representation of the condenser system used in FIG. 1. The lens arrays 4, which are respectively provided as two tandem cylinder lens arrays 23, 24, are respectively arranged between the light sources 1-3 and the color unit 5.

Tandem lens arrays as used herein means that one lens array 231, 232; 241, 242 each are arranged on the front and rear surfaces of a substrate, which are identical in this case and adjusted relative to each other. The substrate thicknesses of both tandem lens arrays 23, 24 are selected such that the focal points of the lenses of the respective lens array 231, 241 on the front surface are located in the principal plane of the lenses of the respective lens array 232, 242 on the rear surface of the substrate (focal length f). The lens arrays 23 and 24 are embodied as two crossed tandem cylinder lens arrays and are adapted to the rectangular surface (imaging region) of the light modulators 15, 16 which is to be illuminated.

The condenser system further comprises the focussing lens 9, whose optical distance to the lens array 242 corresponds to the focal length F of the focussing lens 9. In the same manner, the optical distance from the focussing lens 9 to the light modulators 15, 16 is also F. The color unit 5, although not shown in FIG. 2, is arranged between the lens array 24 and the focussing lens 9. The tandem cylinder lens arrays 23, 24 are preferably arranged such that they are rotated 90° relative to each other, thus allowing adjustment of the desired rectangular aspect ratio of the imaging regions of the light modulators 15 and 16. On the whole, the condenser system represented in FIG. 2 leads to a very homogeneous illumination of the imaging regions of the light modulators 15 and 16.

FIG. 3 shows a second embodiment of the projection device according to the invention, wherein the same elements as in FIG. 1 are indicated by the same reference numerals and, for description thereof, reference is made to the above description.

In contrast to the embodiment of FIG. 1, the projection device of FIG. 3 is provided with one pre-polarizer 30, 31, 32 each between the light sources 1-3 and the respective lens arrays 4. The pre-polarizer 30 effects a linear polarization of the green light such that it is s-polarized with respect to the splitting surface 14. The pre-polarizers 31 and 32 effect a linear polarization of the blue and red light such that it is p-polarized with respect to the splitting surface 14. Further, instead of the color cube 5, a polarization-sensitive color unit 33 is provided, which comprises two intersecting, polarization-sensitive layers 34, 35 that transmit (with respect to the splitting surface 14) s-polarized light (i.e. the green light) and reflect (with respect to the splitting surface 14) p-polarized light (i.e. the red and blue light). The remaining structure corresponds to that of FIG. 1.

The light modulators 15 and 16 are LCoS modules in this case.

Instead of the polarizing beam splitter 13, wire grid polarizers may also be used, for example, in which case adjustments of the elements influencing the polarization direction may possibly have to be effected.

Instead of the polarization-sensitive light modulators, mirror matrices may also be used. In this case, the separation of the green light, on the one hand, and of the red and blue light, on the other hand, is preferably effected by dichroic layers.

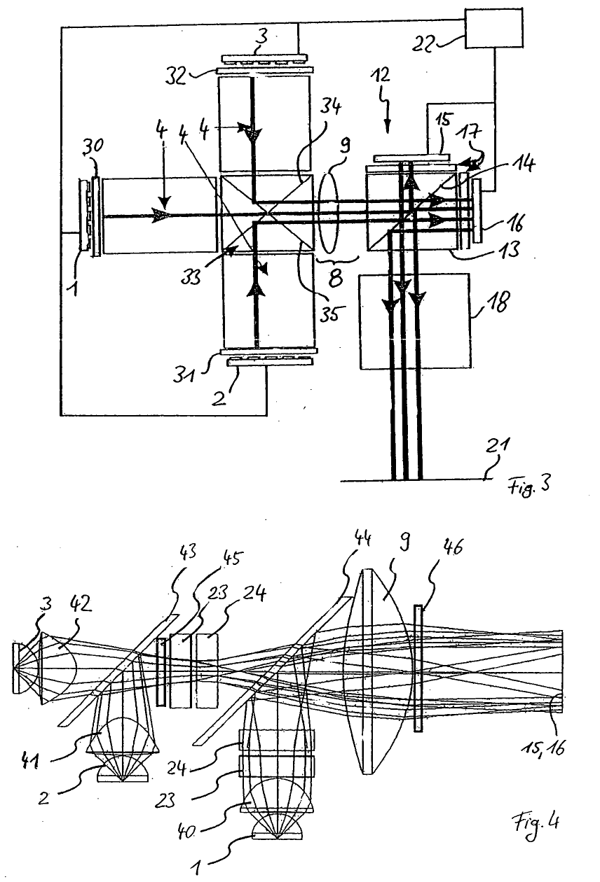

FIG. 4 shows a further embodiment of the projection device according to the invention, wherein the optical elements following after the illumination channel 8 are not shown in detail, but only the position of the light modulators 15 and 16 is schematically indicated. However, the exact design of this part of the projection device may be effected in the same manner as in FIG. 1 or as in FIG. 3, for example. Further, those elements of the embodiment of FIG. 4 which are the same as those of the already described embodiments are described by the same reference numerals. For a description of these elements, reference is made to the above comments.

The embodiment shown in FIG. 4 differs essentially from the already described embodiments in that the light sources 1, 2 and 3 each only comprise a single light emitting diode following which there are arranged respective collimator optics 40, 41 and 42. The collimator optics 40, 41 and 42 are each provided as aspheric lenses.

A further difference to the above-described embodiments consists in that only one single tandem lens array 4 needs to be provided for the second and third light sources 2, 3, because the light from the second and third light sources is supplied to the tandem lens array comprising the lens arrays 23 and 24 via a wire grid polarizer 43. Because the wire grid polarizer reflects s-polarized light and transmits p-polarized light, the transmitted red and blue light are given the same polarization condition by means of a color-selective retarder 45, and because the second combining unit 44, which superimposes the light from the two light sources 2, 3 coming from the first combining unit 43 onto the light from the first light source, is also provided as a wire grid polarizer, the polarization direction of the red light is rotated 90° here by means of the retarder 45, so that the red light reflected by the first wire grid polarizer 45 is p-polarized thereafter in the same manner as the blue light transmitted by the wire grid polarizer 43. Said p-polarized light is transmitted by the second wire grid polarizer 44 and said s-polarized green light is reflected by the second wire grid polarizer 44, so that all three colors are coupled into the illumination channel. Depending on the particular application, a further color-selective retarder 46 may then optionally be provided as illustrated.

1. A projection device comprising first, second and third light sources, which emit light of different wavelengths, wherein, by additive mixing of colors of the light from said three light sources, the maximum luminous flux at the white point is limited by the maximum luminous flux of the first light source, a color unit coupling the light from the light sources into an illumination channel, a light modulator device, which immediately follows the illumination channel and modulates the light from the light sources, and projection optics projecting the modulated light onto a projection surface, wherein the light modulator device comprises first and second light modulators as well as a color-splitting unit arranged preceding said light modulators, said color-splitting unit having the light from the illumination channel impinging thereon and directing the light from the first light source onto the first light modulator and the light from the second and third light sources onto the second light modulator, and wherein a color-combining unit, which directs the modulated light coming from the light modulators to the projection optics, and a control unit are provided, which causes the second light modulator to be illuminated with the light from the second and third light sources sequentially in time, and which effects a white balance adjustment via at least one of the intensity and on-state times of the light sources.

2. The projection device as claimed in claim 1, wherein the control unit controls the application of the light from the light sources to the light modulators such that, at a given color temperature, a luminous flux limited by the luminous flux of the first light source is achieved at the white point.

3. The projection device as claimed in claim 1, wherein the light sources each comprise light emitting diodes.

4. The projection device as claimed in claim 3, wherein the light emitting diodes emit red, green and blue light.

5. The projection device as claimed in claim 1, wherein the light modulators are each reflective light modulators and the color-splitting unit and the color-combining unit are the same unit.

6. The projection device as claimed in claim 1, wherein the color unit couples light into the illumination channel, independently of the polarization of the light from the light sources, and comprising in the illumination channel a first polarization unit which imposes a different polarization condition on the light from the first light source than that of the light from the second and third light sources, wherein the color-splitting unit effects color splitting as a function of the polarization condition of the light.

7. The projection device as claimed in claim 1, wherein the color unit is polarization-sensitive and the light from the first light source of the color unit is supplied with a different polarization condition than the light from the second and third light sources, and in which the color-splitting unit effects color splitting as a function of the polarization condition of the light.

8. The projection device as claimed in claim 6, wherein the light modulators comprise polarization-sensitive light modulators.

9. The projection device as claimed in claim 7, wherein the light modulators comprise polarization-sensitive light modulators.

10. The projection device as claimed in claim 1, further comprising a second polarization unit, which converts the modulated light from the light modulators into the same polarization condition, between the color-combining unit and the projection optics.

11. The projection device as claimed in claim 1, further comprising a first lens array between at least one of the light sources and the color unit, and focusing optics having positive refractive power between the color unit and the light modulators, wherein the first lens array and the focusing optics form a honeycombed condensor system.

12. The projection device as claimed in claim 11, wherein the optical distance from the focusing optics to the first lens array and from the focusing optics to the light modulators respectively correspond to the focal length of the focusing optics.

13. The projection device as claimed in claim 11, wherein the honeycombed condensing system comprises a second lens array between the first lens array and the corresponding light source.

14. The projection device as claimed in claim 13, wherein the focal points of the lenses of the second lens array are located in the plane of the first lens array.

15. The projection device as claimed in claim 13, wherein both lens arrays are provided as a first tandem lens array.

16. The projection device as claimed in claim 15, wherein a second tandem lens array is arranged between the first tandem lens array and the light source.

17. The projection device as claimed in claim 11, wherein at least one lens array comprises a cylinder lens array.

18. The projection device as claimed in claim 11, wherein the focusing optics comprise a Fresnel lens.

19. The projection device as claimed in claim 11, wherein the focusing optics comprise an aspheric lens.

20. The projection device as claimed in claim 11, wherein the color unit comprises first and second combining units, with the first combining unit directing the light from the second and third light sources into a partial beam path extending from the first combining unit to the second combining unit, in which one of the lens arrays comprises a first microlens arrays arranged as common microlens array for the second and third light sources, and the second combining unit directs the light from the partial beam path and the light from the first light source into the illumination channel.

21. The projection device as claimed in claim 1, wherein the color unit comprises a polarizing beam splitter.

22. A projection device comprising:
a first, second and third light source, each light source emitting light of a different wavelength wherein, by additive mixing of colors of the light from the first, second and third light sources, maximum luminous flux at the white point is limited by the maximum luminous flux of the first light source;
a color unit coupling the light from the first, second and third light sources into an illumination channel;
a light modulator unit, immediately following the illumination channel; and
projection optics to project the modulated light onto a projection surface;
in which the light modulator unit comprises first and second light modulators and a color-splitting unit positioned preceding the first and second light modulators, the color-splitting unit having the light from the illumination channel impinging thereon and directing light from the first light source onto the first light modulator and light from the second and third light sources onto the second light modulator, and further comprising a color-combining unit, which directs modulated light coming from the first and second light modulators to the projection optics, and further comprising a control unit, which illuminates the second and third light sources sequentially in time, and which adjusts white balance via intensity, on-state times of the light sources or a combination of the foregoing.

23. The projection device as claimed in claim 22, wherein the control unit controls the application of the light from the light sources to the light modulators such that, at a given color temperature, a luminous flux limited by the luminous flux of the first light source is achieved at the white point.

24. The projection device as claimed in claim 22, wherein the light sources each comprise light emitting diodes.

25. The projection device as claimed in claim 24, wherein the light emitting diodes emit red, green and blue light.

26. The projection device as claimed in claim 22, wherein the light modulators are each reflective light modulators and the color-splitting unit and the color-combining unit are combined in the same unit.

27. The projection device as claimed in claim 22, wherein the color unit couples light into the illumination channel, independently of the polarization of the light from the light sources, and comprising in the illumination channel a first polarization unit which imposes a different polarization condition on the light from the first light source than that of the light from the second and third light sources, wherein the color-splitting unit effects color splitting as a function of the polarization condition of the light.

28. The projection device as claimed in claim 22, wherein the color unit is polarization-sensitive and the light from the first light source of the color unit is supplied with a different polarization condition than the light from the second and third light sources, and in which the color-splitting unit effects color splitting as a function of the polarization condition of the light.

29. The projection device as claimed in claim 27, wherein the light modulators comprise polarization-sensitive light modulators.

30. The projection device as claimed in claim 28, wherein the light modulators comprise polarization-sensitive light modulators.

31. The projection device as claimed in claim 22, further comprising a second polarization unit, which converts the modulated light from the light modulators into the same polarization condition, between the color-combining unit and the projection optics.

32. The projection device as claimed in claim 22, further comprising a first lens array between at least one of the light sources and the color unit, and focusing optics having positive refractive power between the color unit and the light modulators, wherein the first lens array and the focusing optics form a honeycombed condenser system.

33. The projection device as claimed in claim 32, wherein the optical distance from the focusing optics to the first lens array and from the focusing optics to the light modulators respectively correspond to the focal length of the focusing optics.

34. The projection device as claimed in claim 32, wherein the honeycombed condensing system comprises a second lens array between the first lens array and the corresponding light source.

35. The projection device as claimed in claim 34, wherein the focal points of the lenses of the second lens array are located in the plane of the first lens array.

36. The projection device as claimed in claim 34, wherein both lens arrays are provided as a first tandem lens array.

37. The projection device as claimed in claim 36, wherein a second tandem lens array is arranged between the first tandem lens array and the light source.

38. The projection device as claimed in claim 32, wherein at least one lens array comprises a cylinder lens array.

39. The projection device as claimed in claim 32, wherein the focusing optics comprise a Fresnel lens.

40. The projection device as claimed in claim 32, wherein the focusing optics comprise an aspheric lens.

41. The projection device as claimed in claim 32, wherein the color unit comprises first and second combining units, with the first combining unit directing the light from the second and third light sources into a partial beam path extending from the first combining unit to the second combining unit, in which one of the lens arrays comprises a first microlens arrays arranged as common microlens array for the second and third light sources, and the second combining unit directs the light from the partial beam path and the light from the first light source into the illumination channel.

42. The projection device as claimed in claim 22, wherein the color unit comprises a polarizing beam splitter.

43. A method of additively mixing colors of light emitted from first, second and third light sources, each emitting light of a different wavelength when the maximum luminous flux at the white point is limited by the maximum luminous flux of the first light source, the method comprising the steps of:
coupling the light from the first, second and third light sources into an illumination channel with a color unit;
locating a light modulator unit, immediately following the illumination channel; and
locating projection optics to project the modulated light onto a projection surface;
including in the light modulator unit first and second light modulators and a color-splitting unit positioned preceding the first and second light modulators,
directing light from the illumination channel to the color-splitting unit and directing light from the first light source onto the first light modulator and light from the second and third light sources onto the second light modulator, and directing modulated light coming from the first and second light modulators to the projection optics, via a color-combining unit; and
utilizing a control unit to illuminate the second and third light sources sequentially in time, or to adjust white balance via intensity, on-state times of the light sources or a combination of the foregoing.

44. The method as claimed in claim 43, further comprising the step of controlling the application of the light from the light sources to the light modulators such that, at a given color temperature, a luminous flux limited by the luminous flux of the first light source is achieved at the white point.

45. The method as claimed in claim 43, wherein the light sources each comprise light emitting diodes.

46. The method as claimed in claim 43, wherein the light emitting diodes emit red, green and blue light.

47. The method as claimed in claim 43, further comprising the steps of selecting reflective light modulators as the light modulators and utilizing a single unit to act as both the color-splitting unit and the color-combining unit.

48. The method as claimed in claim 43, further comprising the steps of coupling light into the illumination channel independently of the polarization of the light from the light sources, and including, in the illumination channel, a first polarization unit which imposes a different polarization condition on the light from the first light source than that of the light from the second and third light sources, wherein the color-splitting unit effects color splitting as a function of the polarization condition of the light.

49. The method as claimed in claim 43, wherein the color unit is polarization-sensitive and further comprising the steps of supplying the light from the first light source of the color unit with a different polarization condition than the light from the second and third light sources, and color splitting as a function of the polarization condition of the light.

50. The method as claimed in claim 48, wherein the light modulators comprise polarization-sensitive light modulators.

51. The method as claimed in claim 49, wherein the light modulators comprise polarization-sensitive light modulators.

52. The method as claimed in claim 43, further comprising the steps of converting the modulated light from the light modulators into the same polarization condition, between the color-combining unit and the projection optics by use of a second polarization unit.

53. The method as claimed in claim 43, further comprising the steps of interposing a first lens array between at least one of the light sources and the color unit, and interposing focusing optics having positive refractive power between the color unit and the light modulators, such that the first lens array and the focusing optics form a honeycombed condensor system.

54. The method as claimed in claim 53, further comprising the steps of adjusting the optical distance from the focusing optics to the first lens array and from the focusing optics to the light modulators respectively to correspond to the focal length of the focusing optics.

55. The method as claimed in claim 53, further comprising the steps of inserting a second lens array between the first lens array and the corresponding light source in the honeycombed condensing system.

56. The method as claimed in claim 53, further comprising the steps of locating the focal points of the lenses of the second lens array in the plane of the first lens array.

57. The method as claimed in claim 53, wherein both lens arrays are provided as a first tandem lens array.

58. The method as claimed in claim 57, further comprising the steps of locating a second tandem lens array between the first tandem lens array and the light source.

59. The method as claimed in claim 55, wherein at least one lens array comprises a cylinder lens array.

60. The method as claimed in claim 43, wherein the focusing optics comprise a Fresnel lens.

61. The method as claimed in claim 43, wherein the focusing optics comprise an aspheric lens.

62. The method as claimed in claim 57, further comprising the steps of equipping the color unit with first and second combining units, the first combining unit directing the light from the second and third light sources into a partial beam path extending from the first combining unit to the second combining unit, and selecting, for one of the lens arrays, a first microlens array arranged as common microlens array for the second and third light sources, and directing the light from the partial beam path and the light from the first light source into the illumination channel the second combining unit.

63. The method as claimed in claim 43, wherein the color unit comprises a polarizing beam splitter.
